(19) United States
(12) Patent Application Publication
(10) Pub. No.: US 2025/0385480 A1
(43) Pub. Date: Dec. 18, 2025

(54) APPARATUS FOR AND METHOD OF CONDITIONING LIGHT SOURCE AFTER IDLE PERIOD

(71) Applicant: Cymer, LLC, San Diego, CA (US)

(72) Inventors: Spencer Ryan Williams, San Diego, CA (US); Mohammad Taghi Mohebbi, San Diego, CA (US)

(21) Appl. No.: 18/876,247

(22) PCT Filed: Jul. 19, 2023
(86) PCT No.: PCT/US2023/028094

§ 371 Date: Dec. 18, 2024

Related U.S. Application Data
(60) Provisional application No. 63/397,046, filed on Aug. 11, 2022.

(51) Int. Cl. H01S 3/104; H01S 3/225

(52) U.S. Cl. CPC H01S 3/104; H01S 3/225

(57) ABSTRACT

A method of and apparatus for conditioning of a laser with one or more chambers after an idle period, is provided. The method of and apparatus invoke conditioning procedures when restarting a laser with one or more chambers after an idle period. One or more of various parameters such as the chamber age and the duration of the idle period preceding restarting the laser may be used to determine whether or what type of conditioning should be performed.

### CROSS-REFERENCE TO RELATED APPLICATIONS

This application claims priority to U.S. application 63/397,046 which was filed on 11 Aug. 2022 and which is incorporated herein in its entirety by reference.

### FIELD

The present disclosure relates to a control apparatus and method for alight source, for example, a deep ultraviolet light source.

### BACKGROUND

Photolithography is the process by which semiconductor circuitry is patterned on a substrate such as a silicon wafer. An optical source generates deep ultraviolet (DUV) light used to expose a photoresist on the wafer. DUV light may include wavelengths from, for example, about 100 nanometers (nm) to about 400 nm. Often, the optical source is a laser source (for example, an excimer laser) and the DUV light is a pulsed laser beam. The DUV light from the optical source interacts with a projection optical system, which projects the beam through a mask onto the photoresist on the silicon wafer. In this way, a layer of chip design is patterned onto the photoresist. The photoresist and wafer are subsequently etched and cleaned, and then the photolithography process repeats as necessary.

### SUMMARY

The following presents a succinct summary of one or more embodiments in order to provide a basic understanding of the embodiments. This summary is not an extensive overview of all contemplated embodiments. It is not intended to identify any elements of embodiments as being key or critical elements nor delineate the scope of any or all embodiments. Its sole purpose is to present some concepts of one or more embodiments in a concise form as a prelude to the more detailed description that is presented later.

According to one aspect of an embodiment there is disclosed a method of determining whether to perform cold start conditioning in restarting a laser after a most recent idle period, the laser having a laser chamber, the method comprising, before the most recent idle period, determining an idle duration trigger threshold based at least in part on a shot count of the laser chamber, and determining whether to perform cold start conditioning after the most recent idle period based at least in part on whether a duration of the most recent idle period exceeds the idle duration trigger threshold.

Determining an idle duration trigger threshold based at least in part on a shot count may comprise determining an idle duration trigger threshold based at least in part on the shot count and on a measured energy of a beam emitted by the laser after an earlier idle period. The cold start conditioning may comprise firing a predetermined number of inoperative pulses.

According to another aspect of an embodiment there is disclosed a method of determining whether to perform cold start conditioning in restarting a laser after a most recent idle period, the laser having a laser chamber, the method comprising making a chamber age determination of whether a shot count of the chamber is less than a first predetermined shot count and setting an idle duration trigger threshold to a default idle duration trigger threshold if the shot count of the chamber is less than the first predetermined shot count. If the chamber age determination is negative, then a beam energy determination is made by recording a duration of an earlier idle period, evaluating an energy of a laser beam exiting the laser after a cold start from the earlier idle period, and if the beam energy exceeds a threshold amount, setting the idle duration trigger threshold based at least in part on the duration of the earlier idle period and the beam energy. If the beam energy determination is negative, then a shot count determination is made based on whether a shot count for the chamber exceeds a predetermined trigger shot count threshold and, if an idle duration exceeds a scheduled adjustable idle duration trigger threshold, then setting the idle duration trigger threshold equal to an adjustable idle duration trigger threshold, and deciding to perform cold start conditioning based at least in part on whether the duration of the most recent idle period exceeds the idle duration trigger threshold.

Making a beam energy determination further may comprise modifying the adjustable idle duration trigger threshold. The cold start conditioning may comprise firing a predetermined number of inoperative pulses.

According to another aspect of an embodiment there is disclosed a method of determining whether to perform cold start conditioning in restarting a laser after a most recent idle period, the laser having a laser chamber, the method comprising making a first determination of whether an age of the chamber is less than a predetermined age and a duration of the most recent idle period exceeds a default idle duration trigger threshold and performing cold start conditioning if the first determination is affirmative. If the first determination is negative, the method includes making a second determination of a duration of the most recent idle period exceeds a then-current idle duration trigger threshold and an energy of a laser beam exiting the laser during an earlier idle period is less than a beam energy trigger threshold and performing cold start conditioning if the second determination is affirmative. If the second determination is negative, the method includes making a third determination of whether a shot count of the chamber exceeds a shot count trigger threshold and the duration of the most recent idle period exceeds an adjustable idle duration trigger threshold and performing cold start conditioning if the third determination is affirmative.

Determining to perform cold start conditioning if a duration of the most recent idle period exceeds an idle duration trigger threshold and an energy of a laser beam exiting the laser during the earlier idle period is less than a beam energy trigger threshold further may comprise setting the idle duration trigger threshold equal to the duration of the most recent idle period.

Determining to perform cold start conditioning if a duration of the most recent idle period exceeds an idle duration trigger threshold and an energy of a laser beam exiting the laser during an earlier idle period is less than a beam energy trigger threshold further may comprise modifying the adjustable idle duration trigger threshold.

The cold start conditioning may comprise firing a predetermined number of inoperative pulses.

According to another aspect of an embodiment there is disclosed a system for determining whether to perform cold start conditioning in restarting a laser after an idle period, the laser having a laser chamber, the system comprising a shot count monitor adapted to monitor a number of shots fired by the laser chamber; an idle period duration monitor adapted to monitor and record respective durations of idle periods when the laser has been idle, a beam energy monitor adapted to monitor an energy of a beam of laser radiation emitted by the laser, and a controller responsively connected to the shot count monitor, the idle period duration monitor, and the beam energy monitor and adapted to determine whether to perform cold start conditioning based on at least one of whether the shot count is below a first predetermined shot count indicating that the chamber is new or has been replaced, whether the shot count is above a second predetermined shot count, a duration of a period when the laser has most recently been idle, and an energy of a beam of laser radiation emitted by the laser after an earlier idle period.

The cold start conditioning may comprise firing a predetermined number of inoperative pulses.

The controller may be adapted to determine whether to perform cold start conditioning by comparing the idle period duration and an idle duration trigger threshold, the idle duration trigger threshold being based on at least one of whether the shot count is below a first predetermined shot count indicating that the chamber is new or has been replaced, whether the shot count is above a second predetermined shot count, a duration of a period when the laser has most recently been idle, and an energy of a beam of laser radiation emitted by the laser after an earlier idle period.

The controller may be adapted to determine the idle duration trigger threshold by making a chamber age determination of whether a shot count of the chamber is less than a first predetermined shot count and setting an idle duration trigger threshold to a default idle duration trigger threshold if the shot count of the chamber is less than the first predetermined shot count.

The controller may be adapted to determine the idle duration trigger threshold by making a beam energy determination by recording a duration of an earlier idle period, evaluating an energy of a laser beam exiting the laser after a cold start from the earlier idle period, and if the beam energy exceeds a threshold amount, setting the idle duration trigger threshold based at least in part on the duration of the earlier idle period and the beam energy.

The controller may be adapted to determine the idle duration trigger threshold by making a shot count determination based on whether a shot count for the chamber exceeds a predetermined trigger shot count threshold and, if an idle duration exceeds a scheduled adjustable idle duration trigger threshold, then setting the idle duration trigger threshold equal to an adjustable idle duration trigger threshold.

Further features and exemplary aspects of the embodiments, as well as the structure and operation of various embodiments, are described in detail below with reference to the accompanying drawings. It is noted that the scope of all possible embodiments is not limited to the specific embodiments described herein. Such specific embodiments are presented herein for illustrative purposes only. Additional embodiments will be apparent to persons skilled in the relevant art(s) based on the teachings contained herein.

### DRAWING DESCRIPTION

The accompanying drawings, which are incorporated herein and form part of the specification, illustrate the embodiments and, together with the description, further serve to explain the principles of the embodiments and to enable a person skilled in the relevant art(s) to make and use the embodiments.

FIGS. 1A-1C are block diagrams of a light source at three different times.

FIGS. 2A-2C are block diagrams of another light source at three different times.

FIG. 2D is a timing diagram for controlling cold start conditioning according to an aspect of an embodiment.

FIG. 3A is a flow chart of a process for controlling cold start conditioning according to an aspect of an embodiment.

FIG. 3B is a flow chart of part of the process for controlling cold start conditioning of FIG. 3A according to an aspect of an embodiment.

FIG. 3C is a flow chart of another part of the process for controlling cold start conditioning of FIG. 3A according to an aspect of an embodiment.

FIG. 3D is a flow chart of another part of the process for controlling cold start conditioning of FIG. 3A according to an aspect of an embodiment.

FIG. 4 is a functional block diagram of a system for controlling cold start conditioning according to an aspect of an embodiment.

FIG. 5 is a block diagram of a photolithography system.

FIG. 6A is a block diagram of an optical lithography system.

FIG. 6B is a block diagram of a projection optical system for the optical lithography system of FIG. 6A.

### DETAILED DESCRIPTION

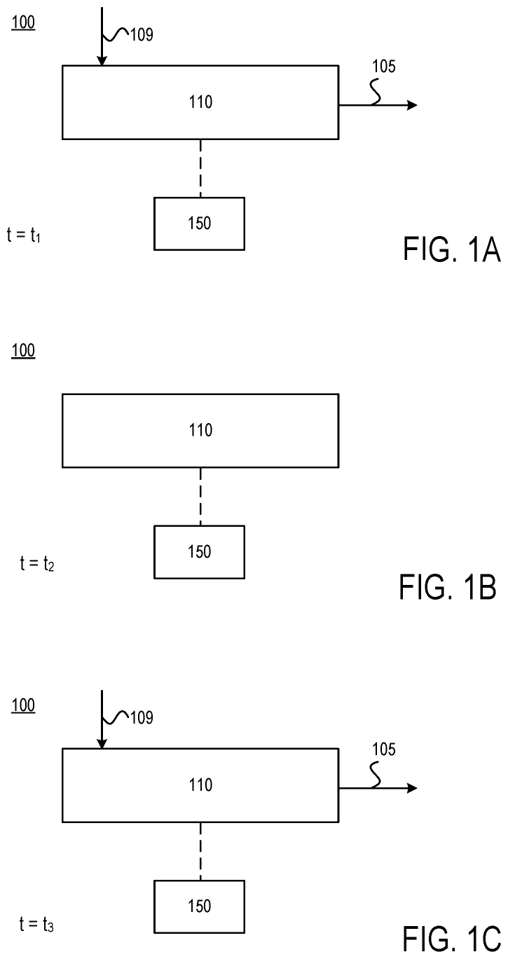

Each of FIGS. 1A-1C is a block diagram of a light source 100 at a different time. FIG. 1A shows the light source 100 at a time t₁. FIG. 1B shows the light source 100 at a time t₂. FIG. 1C shows the light source 100 at a time t₃. The time t₁ occurs during a first time period, the time t₂ occurs during a second time period, and the time t₃ occurs during a third time period. The first time period occurs before the second time period, and the second time period occurs before the third time period. Three time periods are shown for illustration purposes. However, the light source 100 may operate over more than three time periods.

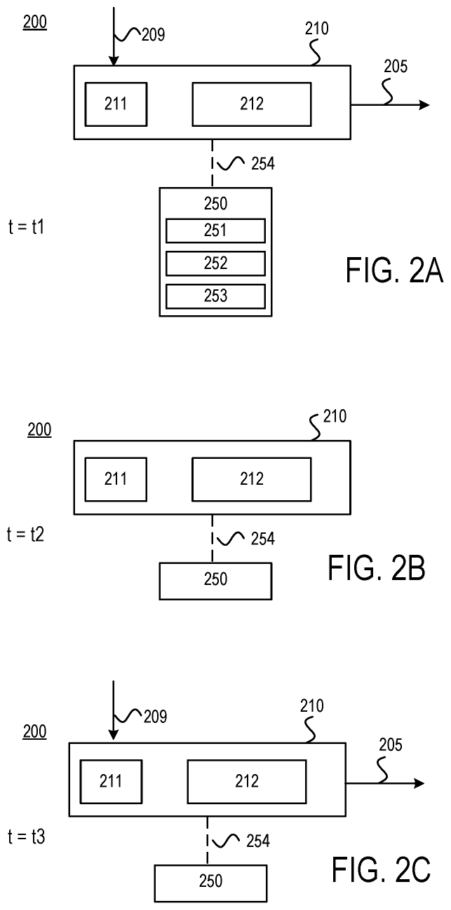

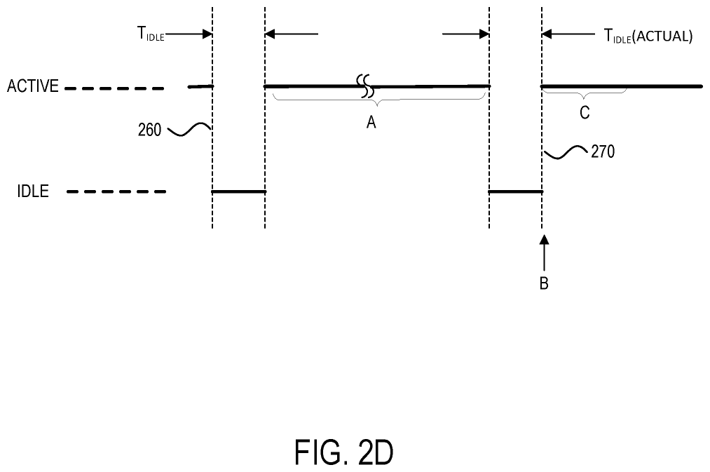

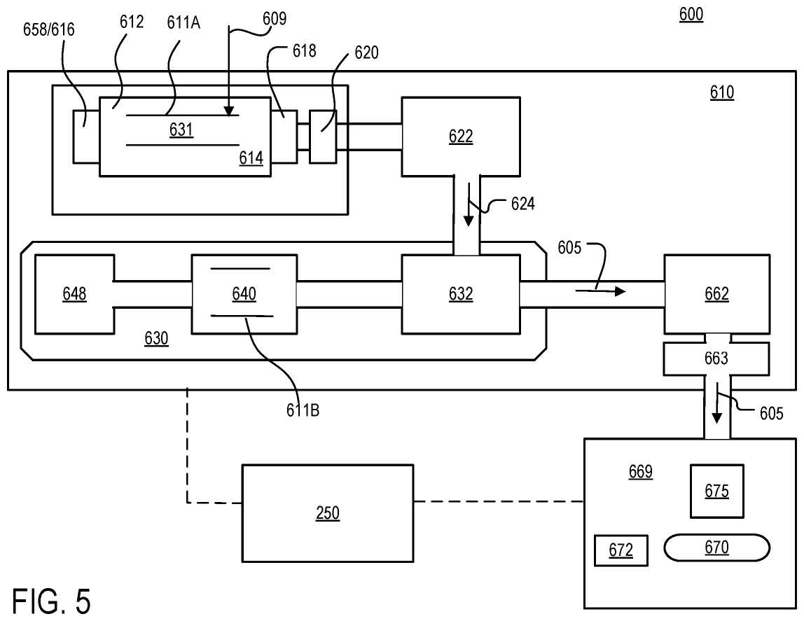

The light source 100 includes a light-generation apparatus 110 and a control system 150, which estimates a property of an excitation signal 109. The excitation signal 109 may be generated by the control system 150 or by a separate apparatus (such as a voltage source or a current source) that is controlled by the control system 150. The excitation signal 109 is any type of signal that is sufficient to cause the light-generation apparatus 110 to generate a light beam 105. For example, the excitation signal 109 may be a signal that is applied to an excitation mechanism (such as the excitation mechanism 211 of FIGS. 2A-2C or the electrodes 611A and 611b of FIG. 5) in the light-generation apparatus 110. The light beam 105 may be, for example, a pulsed or continuous wave laser beam. The light-generation apparatus 110 may be a DUV optical system that emits a pulsed light beam in the DUV range. In some implementations, the light-generation apparatus 110 emits a burst of pulses during each active period.

A burst of pulses may include hundreds or thousands of pulses of light.

The excitation signal 109 is applied to the light-generation apparatus 110 or a component of the light-generation apparatus 110 when the light-generation apparatus 110 is in an active state. The light-generation apparatus 110 produces the light beam 105 during the active state. The light-generation apparatus 110 also has an inactive or idle state. While in the inactive or idle state, the excitation signal 109 is not applied to the light-generation apparatus 110 or its components, and the light-generation apparatus 110 does not produce the light beam 105. During the idle or inactive state, the light-generation apparatus 110 may be, for example, powered off or turned off, or powered on and not producing any light. In the example of FIGS. 1A-1C, the light-generation apparatus 110 is in the active state in the first and third time periods and the idle state in the second time period. The temporal duration of the second time period is also referred to as the idle time, and the second time period is also referred to as the idle period.

The control system 150 may estimate a property of the excitation signal 109 to apply to the light-generation apparatus 110 during the third time period based on the duration of the idle period and a value of the property of the excitation signal 109 that was applied to the light-generation apparatus 110 during a prior active time period (for example, the first time period). The property may be, for example, an energy of a voltage and/or current signal provided to an excitation mechanism in the light-generation apparatus 110.

By determining the property of the excitation signal 109 using the duration of the idle time and a value of the property during the first time period, the control system 150 improves the performance of the light source 100. For example, some prior techniques determine the excitation signal based only on the duration of the idle time. These prior techniques, for example, use a predetermined excitation signal if the duration of the idle time is greater than a predetermined threshold and/or cause the light-generation apparatus 110 to enter into a cold start conditioning mode if the idle time is greater than the predetermined idle time threshold.

On the other hand, the control system 150 may implement a technique that takes into account a prior value of the property of the excitation signal 109 to estimate an updated value of the excitation signal 109. This approach when employed by the control system 150 results in a more accurate determination of the property of the excitation signal 109 to be applied in the third time period and improves the use of the cold start conditioning procedure. For example, the control system 150 reduces or eliminates unnecessary performance of the cold start conditioning procedure, also called the cold start conditioning procedure, while also helping to ensure that the cold start conditioning procedure is invoked appropriately. i.e., only when necessary.

Moreover, the control system 150 also may determine an adaptive parameter that accounts for changes in one or more characteristics of the light-generation apparatus 110 over time. For example, the energy efficiency of the light-generation apparatus 110 may change over time. The energy efficiency is a relationship between the amount of energy that is provided to the light-generation apparatus 110 to produce light having a certain amount of energy. For example, in implementations in which the excitation signal 109 is a voltage signal that is applied to electrodes in the light-generation apparatus 110, as the energy efficiency of the light-generation apparatus 110 decreases, a greater amount of voltage is needed to produce a light beam 105 having a same amount of energy as previously. The energy efficiency of the light-generation apparatus 110 also may decrease during the idle time. As discussed in greater detail below, the adaptive parameter may estimate and track changes in the energy efficiency of the light-generation apparatus 110. By accounting for characteristics of the light-generation 110 that change over time, the control system 150 improves the accuracy of the estimate of the property of the excitation signal 109.

Referring to FIGS. 2A-2C, block diagrams of a light source 200 are shown. The light source 200 is an implementation of the light source 100. Each of FIGS. 2A-2C shows the light source 200 at a different time. The light source 200 is shown in the active state in FIGS. 2A and 2C and in the idle state in FIG. 2B. The light source 200 includes a light-generation apparatus 210 and a control system 250.

The light-generation apparatus 210 includes an excitation mechanism 211 and a gain medium 212.

The light-generation apparatus 210 produces alight beam 205 in the active state. The excitation signal 209 is applied to the light-generation apparatus 210 and excites the excitation mechanism 211 when the light-generation apparatus 210 is in the active state (FIGS. 2A and 2C). The light-generation apparatus 210 also has an inactive or idle state (FIG. 2B). When the light-generation apparatus 210 is in the idle state, the excitation signal 209 is not applied to the light-generation apparatus and does not excite the excitation mechanism 211. In the example of FIGS. 2A-2C, the light source 200 is in the active state during a first time period (which includes the time t1) and a third time period (which includes the time t3). The light source 200 is in the idle state during a second time period (which includes the time t2). The duration of the second time period is also referred to as the idle time. Three time periods are shown for illustration purposes. However, the light source 200 may operate over more than three time periods.

The excitation mechanism 211 excites the gain medium 212 in response to the excitation signal 209. The gain medium 212 is any medium suitable for producing a light beam at the wavelength, energy, and bandwidth required for the application. For example, the gain medium 212 may be a gas, a crystal, a glass, a semiconductor, or a liquid.

The excitation mechanism 211 is any mechanism capable of exciting the gain medium 212. For example, the excitation mechanism 211 may be a plurality of electrodes that excite a gaseous gain medium. The excitation signal 209 may be, for example, an electrical signal (such as a voltage signal) or a command signal that causes an additional element (such as a voltage or current source) to generate an electrical signal that is provided to the excitation mechanism 211. The excitation signal 209 may be a time-varying direct current (DC) electrical signal or an alternating current (AC) electrical signal, such as a sine wave voltage signal or a square wave voltage signal or a combination of these. In these implementations, the property of the excitation signal 209 may be the maximum amplitude of the time-varying signal, the average amplitude of the time-varying signal, the minimum amplitude of the time-varying signal, the frequency of the time-varying signal, the duty cycle of the time-varying signal, and/or or any other property related to the time-varying signal.

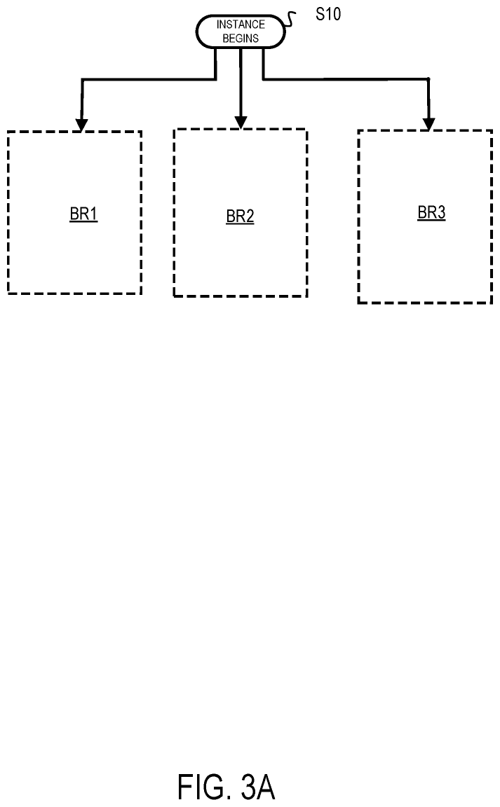

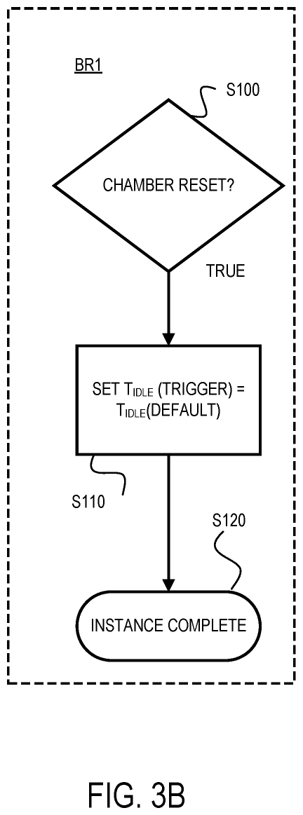

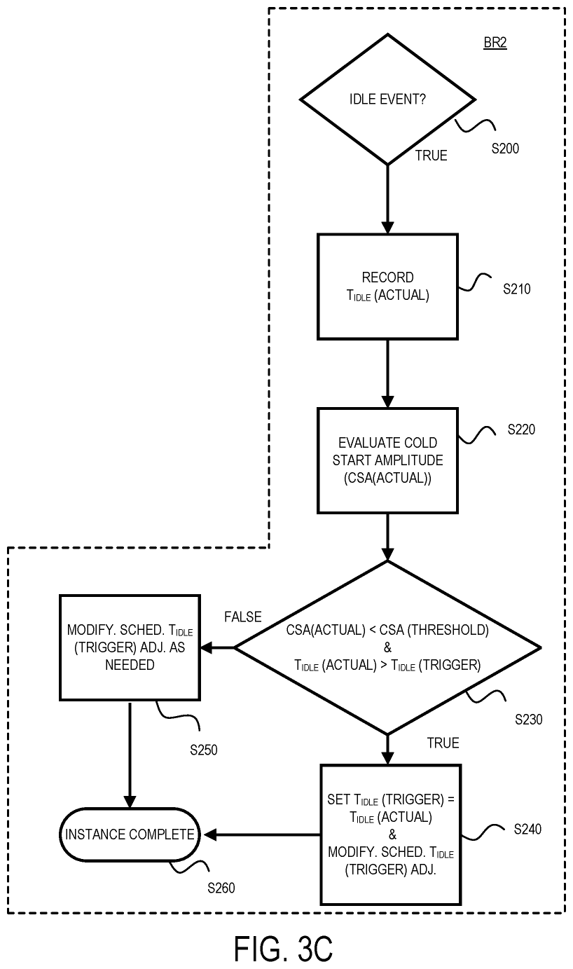

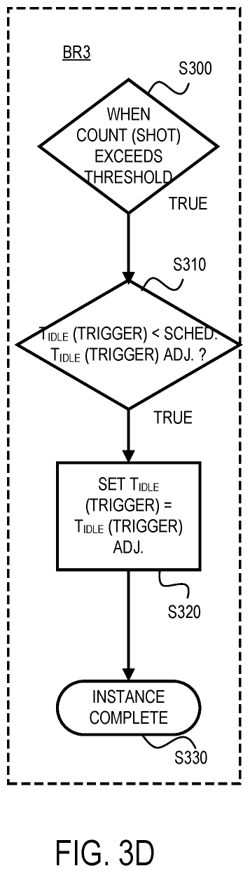

The control system 250 estimates the property of the excitation signal 209. The property may be, for example, an amplitude, frequency, and/or duty cycle of a voltage and/or current signal provided to the excitation mechanism 211 in the light-generation apparatus 210. The control system 250 estimates the property of the excitation signal 209 based on a prior or earlier idle time and a prior or earlier value of the property of the excitation signal 209. To estimate the property of the excitation signal 209, the control system 250 may implement a process such as the process described with respect to FIGS. 3A-3D. Moreover, the control system 250 may be used with any type of optical source. For example, the control system 250 may be used with the photolithography system 600 (FIG. 5).

The control system 250 includes an electronic processing module 251, a computer-readable memory module 252, and an I/O interface 253. The electronic processing module 251 includes one or more processors such as a general or special purpose microprocessor, and any one or more processors of any kind of digital computer. Generally, an electronic processor receives instructions and data from a read-only memory, a random access memory (RAM), or both. The electronic processor or processors of the electronic processing module 251 execute instructions and access data stored on the memory module 252. The electronic processor or processors are also capable of writing data to the memory module 252.

The memory module 252 may be volatile memory, such as RAM, or non-volatile memory. In some implementations, and the memory module 252 includes non-volatile and volatile portions or components. The memory module 252 may store data and information that is used in the operation of the control system 250. For example, the memory module 252 may store information related to the idle period and information related to the value of the property of the excitation signal 209 applied to the light-generation apparatus 210 during one or more time periods that occurred prior to the most recent idle time. The memory module 252 may store one or more values associated with the excitation signal 209 applied during the active period that occurred immediately prior to the most recent idle period. For example, the excitation signal 209 may be a voltage signal or a signal that specifies voltages to be produced by a voltage source. In this example, the memory module 252 may store the average, minimum, and maximum values of the voltage signal during the most recent active period. The memory module 252 also may store information received from the light source 200 and/or the light-generation apparatus 210.

The I/O interface 253 is any kind of interface that allows the control system 250 to exchange data and signals with an operator, the light-generation apparatus 210, and/or an automated process running on another electronic device. For example, in implementations in which rules or instructions stored in the memory module 252 may be edited, the edits may be made through the I/O interface 253. In another example, the I/O interface 253 receives data from the light-generation apparatus 210 and/or from hardware and/or software subsystems of the light-generation apparatus 210. For example, the light-generation apparatus 210 may provide the control system 250 with the duration of the idle time and other information about the light-generation apparatus 210 through the I/O interface 253. The I/O interface 253 may include one or more of a visual display, a keyboard, and a communications interface, such as a parallel port, a Universal Serial Bus (USB) connection, and/or any type of network interface, such as, for example, Ethernet. The I/O interface 253 also may allow communication without physical contact through, for example, an IEEE 802.11, Bluetooth, or a near-field communication (NFC) connection.

The control system 250 is coupled to the light-generation apparatus 210 through a data connection 254. The data connection 254 may be a physical cable or other physical data conduit (such as a cable that supports transmission of data based IEEE 802.3), a wireless data connection (such as a data connection that provides data via IEEE 802.11 or Bluetooth), or a combination of wired and wireless data connections. The data that is provided over the data connection may be set through any type of protocol or format. The data connection 254 is connected to the light-generation apparatus 210 at respective communication interfaces (not shown). The communication interfaces may be any kind of interface capable of sending and receiving data. For example, the data interfaces may be an Ethernet interface, a serial port, a parallel port, or a USB connection. In some implementations, the data interfaces allow data communication through a wireless data connection. For example, the data interfaces may be an IEEE 811.11 transceiver, Bluetooth, or an NFC connection. The control system 250 may be connected to systems and/or components within the light-generation apparatus 210. For example, the control system 250 may be connected to the excitation mechanism 211.

In the example of FIGS. 2A-2C, the control system 250 is shown as being separate from the light-generation apparatus 210 and connected via the data connection 254. However, in some implementations, the control system 250 is implemented as part of the light-generation apparatus 210 such that the light-generation apparatus 210 and the control system 250 are part of a single, integrated package (for example, enclosed within the same housing). In these implementations, the data connection 254 may be a data path that allows communication between software modules with one of the software modules implementing aspects of the control system 250 and the other of the software modules implementing other functionality for the light-generation apparatus 210.

The control system for the laser may include a computer that interfaces with a computer in an overall control system. In one control paradigm, the overall control system computer obtains data from the laser computer and then reconfigures the laser operating parameters. The overall control computer then writes the reconfigured operational parameters to the laser computer. This achieves a configurable control paradigm.

An effect which is more pronounced in “young” chambers (that is, chambers which have produced less than a given number of pulses) is a “cold start event” by which the gain generation falls off significantly after an idle period. The size of the effect depends on many things including but not limited the construction details of the chamber as well as the number of pulses to which it is exposed. The duration of the idle period may be as short as a minute or so. In other words, during such an idle period, when the laser is dark and not firing, the laser enters the state in which its gain loss will be significant during the initial pulses of the next burst.

Restarting the laser after it has been idle can thus lead to a “cold start event” in which the laser gain is at a decreased level during the initial pulses of the next burst. In other words, immediately after an idle period, the laser may produce a beam for a given excitation voltage that is significantly weaker than the beam the laser will produce for the same excitation voltage when the laser has achieved a stable operating condition. This fall-off in beam energy can reduce the yield of manufacturing processes using the beam. As mentioned, the likelihood of a cold start event, i.e., the onset of a cold start instability after the laser has been idle is a function of, among other things, the age of the laser chamber, usually in terms of a shot count, i.e., the number of shots (pulses) that the chamber has fired.

As described, a laser may have one or more than one laser chamber. In the description that follows the master oscillator (MO) chamber will be used as an example, but it will be understood that the description also applies to other types of chambers which may be present such as the power amplifier (PA) chamber. Newer chambers (e.g., having a shot count fewer than about 5 billion pulses) tend to be more prone to a cold start event than more mature chambers (e.g., having a shot count exceeding about 10 billion pulses). This is not a hard-and-fast rule, however, and different lasers may exhibit different age-dependent cold start behaviors. For example, even some young lasers are not prone to laser cold start events. For other lasers, it is possible that the phenomenon does not emerge until the laser has been idle for significantly longer than one minute, for example, 5 minutes, 10 minutes, or never. Thus, the probability of undergoing a cold start event varies laser-to-laser.

With a newer chamber with a low shot count, one control method that may be employed is to measure the duration of any idle period and, if the measured duration of the idle period exceeds a predetermined threshold (e.g., one minute), then invoke a cold start conditioning procedure in which the laser is caused to fire a predetermined number of inoperative shots. Herein, the term “inoperative” is used to refer to shots or pulses which are not used for device fabrication, e.g., not to pattern a substrate but which instead are deflected or blocked before they can reach the substrate. Thus, one method of addressing cold start instability is to determine when a chamber is new (low shot count) or has been replaced, which normally involves a reset of the shot count for the chamber.

A control method such as that just described sets up a tradeoff between machine availability (no availability when firing nonoperational shots) and machine dependability (the ability to operate with an acceptably low likelihood of errors that impair production).

In general, resolution of this tradeoff skews towards dependability but it would be beneficial if greater availability could be achieved without unduly compromising dependability.

In the method just described, the cold start conditioning trigger is static for all time, yet the cold start effects themselves are not. The size of cold start effects vary dramatically across parts and across part life, especially at idle times as short as one minute. Therefore cold start conditioning is executed without regard to the need for its protection. While this provides the lowest amount of risk to a cold start related error, it also removes a nontrivial amount of availability of some tools. Each instance of the cold start conditioning protection can cost about on the order of ten seconds. Because cold start effects become weaker with chamber age, and because of the relatively small number of tools that experience critical cold start issues at short idle times, a significant fraction of this availability can be returned to users.

This means that a blanket approach to avoiding laser cold start events can result in significant unnecessary laser unavailability especially when considered as the cumulative loss of availability over an extended period of time, e.g., a year. Thus, for some applications it may be advantageous to implement a control method that entails less of a tradeoff by adapting the decision to whether to perform a cold start procedure to specific circumstances. According to an aspect of an embodiment, an adaptive control method is implemented which tunes the idle duration trigger based on the observed need of the system. This is accomplished by checking multiple triggers. The triggers may be checked concurrently or consecutively. In the example that follows, three triggers are checked with descending priority. Each of the triggers is the initial step of a conditional execution branch. In other words, execution along a given branch is conditional on one or more condition parameters and execution of a higher priority branch.

For example, in one branch, it may be determined whether the chamber is new, i.e., never before used as, for example, when the laser is new or when a chamber has been swapped out for a replacement chamber. If so, then, based on an assumption that a new chamber is more likely to exhibit a cold start event, the logic may require only a determination of whether the duration of the idle period exceeds a predetermined trigger duration. Here it should be noted that the determination of whether a chamber is new may be based on the running shot count associated with the chamber. One function performed by one or both of the computers is to keep track of the shot count for a given chamber. This shot count is typically reset when a chamber is replaced.

In a second branch of the control logic, if an idle event is detected then a record is made of the idle period duration. Then the magnitude of the cold start laser energy output is evaluated. Then it is determined (1) whether the magnitude of the cold start laser energy output is less than a predetermined trigger magnitude and (2) whether the duration of the idle period exceeds a predetermined idle trigger amount. If both conditions are true then the idle duration trigger is reset to the recorded idle period duration and a scheduled trigger adjustment is modified. If, however, it is determined that the magnitude of the cold start laser energy output is not less than the given trigger and that the duration of the idle period does not exceed the trigger duration then no parameters are changed with the exception that the scheduled trigger adjustment may be adjusted.

In a third branch of logic for the process, according to another aspect of an embodiment, when the chamber shot count exceeds a predetermined threshold and the idle trigger duration is less than a scheduled idle trigger adjustment then the idle duration trigger is set to the scheduled idle trigger adjustment.

It should be noted that in some embodiments there is potential for interaction between the second branch of this process and the third branch of this process as described above. The scheduled idle trigger adjustment can be changed both in the second branch of the process and the third branch of the process. This provides robustness and flexibility in the sense that if some external event is causing an older chamber to be prone to cold start events, then the idle trigger adjustment can be reset and the chamber can be treated as if it were a younger chamber until it ceases to exhibit cold start events as if it were a young chamber. According to an aspect of an embodiment, the second branch supersedes the third branch in the sense that when a cold start event is positively detected in the second branch, the second branch may also adjust the scheduled adjustment to the idle duration threshold trigger to account for the data connected to the detected cold start event.

One aspect of an embodiment is that data for idle events that occurred between instances are detected and stored for analysis. For each idle instance, the beam energy of the corresponding cold start behavior is characterized. If that beam energy is less than a trigger and the duration of the idle period is greater than the current value of the idle trigger, then the idle trigger will be updated to this longer value. In this way, if cold start effects are sufficiently small at a given idle time, the idle trigger will be pushed out accordingly. Whether the idle trigger is updated by the idle event observation or not, a scheduled adjustment to the idle trigger may be updated as well.

The initial value of the scheduled idle trigger adjustment may be tuned empirically. However, if during an idle event analysis it is found that there is a large cold start effect at a specific idle event, then the scheduled idle trigger adjustment is adapted to compensate for that observed behavior. In this way the pre-scheduled increase to idle trigger can also account for the actual cold start risk detected within the system.

The idle event data described above is used to determine a parameter for cold start conditioning. One such parameter may be a “go/no go” parameter, i.e., a determination of whether cold start conditioning should be performed at all. Another parameter may be, for example, a length of cold start conditioning. i.e., whether to perform a full cold start conditioning by firing a first number of inoperative shots, or whether to perform a truncated cold start conditioning of fewer than the first number of inoperative shots.

FIG. 2D is a timing diagram for a process for controlling cold start conditioning according to an aspect of an embodiment. A first idle period 260 occurs when the laser output drops from active to idle. This first idle period has a duration T_{IDLE}. During a time interval A after the next burst has started, an idle trigger threshold level is determined based on, for example, the duration T_{IDLE}, the output laser energy immediately after the idle period 260, and chamber age as determined by its shot count. Then, at a later idle period 270, a determination is made at a point B whether to perform cold start conditioning in time interval C based on the trigger threshold level determined in time period A and the actual duration of the idle period 270, that is, T_{IDLE}(ACTUAL). It will be noted that the time duration A may include no additional idle periods or may include one or more additional idle periods.

In other words, according to an aspect of an embodiment, the laser will perform cold start conditioning following a sufficiently long idle period based on the configuration of the laser at the instant following the idle period. Then, asynchronously to first idle period, that is, sometime later, the control system will analyze data pertaining the idle period and determine whether the that the laser's configuration, e.g., the idle duration trigger threshold, needs to be updated going forward. Thus the determination to update the parameters triggering cold start conditioning will typically occur between the idle period used to determine whether parameters require updating and the idle period for which the parameters will be applied in determining whether to perform cold start conditioning.

In the description below the following terms have the corresponding meanings.

COUNT(SHOT) is the measured shot count of a chamber.

T_{IDLE}(ACTUAL) is the actual, measured duration of an idle period.

T_{IDLE}(DEFAULT) is the default idle trigger threshold, that is, the default value of the duration of the idle period which, if exceeded, triggers a cold start conditioning if other parameters permit.

T_{IDLE}(TRIGGER) is the current trigger threshold duration of an idle period, that is, the currently operative value of the duration of the idle period which, if exceeded, triggers a cold start conditioning if other parameters permit.

CSA(ACTUAL) is the measured beam cold start amplitude, that is, the energy of the beam being generated by the chamber.

CSA(THRESHOLD) is the trigger threshold for evaluating CSA, that is, the current value for beam energy which, if not equaled or exceeded, triggers a cold start conditioning if other parameters permit.

SCHED. T_{IDLE}(TRIGGER) ADJ. is a scheduled (for example determined by shot count) adjustment to T_{IDLE}(TRIGGER), that is, the value of an adjustment to the current trigger threshold duration of an idle period scheduled on the basis of shot count unless otherwise modified, for example, based on a determination that the shot count may not be functionally indicative of the actual chamber age or condition.

The duration of the idle period is the length of the continuous time period during which the light-generation apparatus is in the idle or inactive state. The duration of the idle period may relate to the duration of an idle period that occurred in the past or may be the duration of the most recent idle period. For example, the duration of the idle period may be the duration of the second time period that includes the time t2 shown in FIG. 2B.

The duration of the idle period may be stored in the memory module 252. In these implementations, the control system 250 accesses the idle period duration value from the memory module 252. The idle period duration value is not necessarily accessed from the memory module 252. For example, in some implementations, the idle period duration is provided by an operator through the I/O interface 253. Moreover, the information relating to the idle period duration may be a numerical value that represents the idle period duration, or the information may take other forms. For example, the information relating to the idle period duration may include a time at which the idle period began and a time at which the idle period ended. In these implementations, the control system 250 is configured to determine the idle period duration based on the accessed information.

FIGS. 3A-3D are a flow chart of a process 300 for controlling cold start conditioning. The process 300 may be performed by a control system that is associated with the light-generation apparatus. For example, the process 300 may be performed by the control system 150 (FIG. 1) or the control system 250 (FIGS. 2A-2C). Referring to FIGS. 2A-2C, the process 300 may be implemented as a collection of instructions (for example, a computer program or computer software) stored in the memory module 252 and performed by one or more electronic processors in the electronic processing module 251.

Referring again to FIGS. 3A-3D, an instance of determining whether cold start conditioning should be performed is started in a step S10. Execution then proceeds along a first branch BR1. In BR1 (FIG. 3B), it is determined in a step S100 whether the chamber has been reset. In other words, it is determined in step S100 whether the chamber is new or has been replaced during a chamber swap out. In general, a field service engineer will set an indication that the chamber has been reset. If it is determined in step S100 the chamber has been reset, then T_{IDLE}(TRIGGER) is set to a default value T_{IDLE}(DEFAULT) in a step S110. The instance is then deemed completed in a step S120 and the determination of whether cold start conditioning should be performed after a subsequent idle period is made on the basis of whether the duration of the subsequent idle period exceeds T_{IDLE}(TRIGGER) which has been reset to T_{IDLE}(DEFAULT). It will be appreciated that the determination of whether the chamber has been reset may be static for a certain period of time, or a certain number of shots, after reset has occurred.

If, however, it is determined in branch BR1 that the chamber has not been reset, then branch BR2 (FIG. 3C) is executed. In a step S200 it is determined whether an idle event has occurred. If an idle event has occurred, then the actual duration of the idle event, T_{IDLE}(ACTUAL), is recorded in a step S210. Then the cold start amplitude CSA(ACTUAL) of the beam immediately after the idle event is determined in a step S220.

In a step S230 it is determined whether CSA(ACTUAL) is less than a predetermined CSA(THRESHOLD) trigger amount. It is also determined whether the recorded duration of the idle period, T_{IDLE}(ACTUAL) is greater than an idle trigger amount T_{IDLE}(TRIGGER). If it is determined in step S230 that both of these conditions are satisfied, then T_{IDLE}(TRIGGER) is set equal to T_{IDLE}(ACTUAL). At the same time, a scheduled idle trigger adjustment T_{IDLE}(TRIGGER) is modified. The instance is then deemed complete in a step S260.

If, however, it is determined in step S230 that each of the conditions is not satisfied, then a scheduled idle trigger adjustment T_{IDLE}(TRIGGER) may be modified in a step S250 and the instance is deemed complete in step S260. The determination of whether cold start conditioning should be performed for a subsequent idle period is then made on the basis of whether the duration of the subsequent idle period exceeds T_{IDLE}(TRIGGER) as reset to T_{IDLE}(ACTUAL).

Thus, branch BR2 is executed when the cold start amplitude indicates that cold start conditioning should be performed for some idle durations greater than the idle trigger where beam amplitude has been affected that while also resetting the idle trigger to the actual idle duration.

If, in essence, the execution of the branch BR2 does not indicate the existence of a cold start condition at the idle trigger amount, then a branch BR3 (FIG. 3D) is executed. In a step S300 it is determined whether the shot count exceeds a predetermined shot count trigger threshold. If the shot count exceeds a predetermined threshold, indicating that the chamber is a mature chamber and less likely to be in a cold start condition, it is determined in step S310 whether the idle duration threshold trigger, T_{IDLE}(TRIGGER), is less than the scheduled idle trigger adjustment, SCHED. T_{IDLE}(TRIGGER) ADJ. If it is, then T_{IDLE}(TRIGGER) is set equal to SCHED. T_{IDLE}(TRIGGER) ADJ. The instance is then deemed complete, and the system will determine the necessity of performing cold start conditioning using the new T_{IDLE}(TRIGGER).

As can be understood from the above, the adjustable SCHED. T_{IDLE}(TRIGGER) ADJ. is not necessarily a static value. If, for example, the execution of branch BR2 indicates that the value of the T_{IDLE}(TRIGGER) is misaligned with actual chamber cold start behavior, that is, for example, that cold start events occur more frequently than would be expected with an older chamber, then branch BR2 has the capacity to modify SCHED. T_{IDLE}(TRIGGER) ADJ. The amount of the adjustment will, in general, depend on the number of unexpected cold start events from an assumed mature chamber. The occurrence of relatively few such events would warrant a smaller modification of the SCHED. T_{IDLE}(TRIGGER) ADJ. while the occurrence of more such events would warrant a larger modification. Such a misalignment can occur, for example, if the shot count is not reset when a new chamber is swapped in.

As mentioned, the above description is in terms of determining whether cold start conditioning should be performed. It is also possible to configure the method and system to determine what type of cold start conditioning should be performed. For example, if the cold start conditioning includes firing a given number of inoperative shots, then the number of inoperative shots could be adapted according to the parameters mentioned above such as chamber age in terms of shot count and beam energy. If the cold start conditioning involves other characteristics such as frequency and duty cycle of the signals used to fire the inoperative shots, then those characteristics could be adapted as well. If the cold start conditioning involves measures other than or in addition to firing inoperative shots, then those measures could be adapted as well.

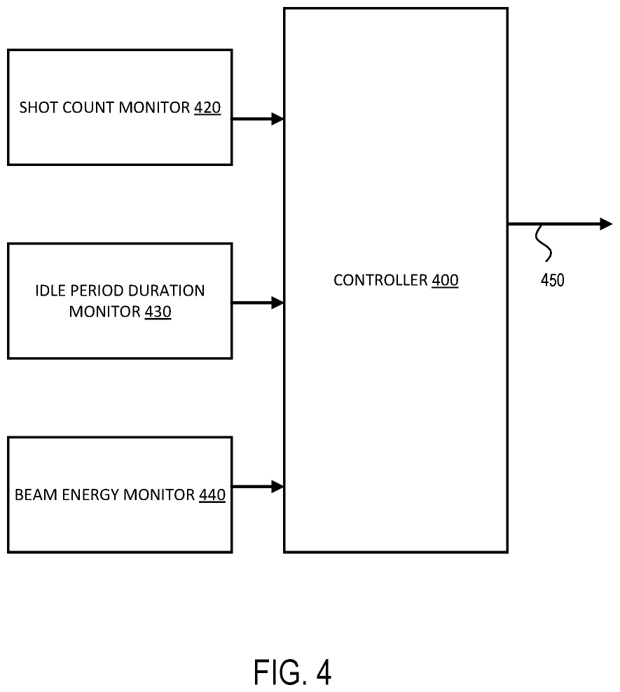

FIG. 4 is a functional block diagram of a system for controlling cold start conditioning in accordance with an aspect of an embodiment. A controller 400, which may correspond to control system 150 (FIG. 1) or control system 250 (FIG. 2) is arranged to receive a signal from a shot count monitor 420, an idle period duration monitor 430, and a beam energy monitor 440. The shot count monitor 420 is, for example, a pulse counter that counts the number of shots that the chamber has fired, indicating the chamber age including whether the chamber has recently been replaced. As described above, the shot count monitor 420 is typically reset by a field service engineer after a chamber has been replaced. The idle period duration monitor records the duration of an idle period, for example, the idle period for which the need for cold start conditioning is being assessed. The beam energy monitor 440 measures the energy of the beam exiting the laser.

The controller 400 receives the signals from these monitors and indicator and processes them in accordance, for example, with the method described above in connection with FIG. 3. The controller 400 then produces an indication 450 of whether cold start conditioning should be performed.

Referring to FIG. 5, a block diagram of a photolithography system 600 is shown. An optical source 610 produces a pulsed light beam 605, which is provided to a lithography exposure apparatus 669. The optical source 610 may be, for example, an excimer optical source that outputs the pulsed light beam 605 (which may be a laser beam). As the pulsed light beam 605 enters the lithography exposure apparatus 669, it is directed through a projection optical system 675 and projected onto a wafer 670 to form one or more microelectronic features on a photoresist on the wafer 670. The photolithography system 600 also includes the control system 250, which, in the example of FIG. 5, is connected to components of the optical source 610 and the lithography exposure apparatus 669. In this example, the control system 250 may receive data related to the pulsed light beam 605 or other information from the lithography exposure apparatus 669 and/or may send commands to the lithography exposure apparatus 669. In other examples, the control system 250 is connected only to the optical source 610.

In the example shown in FIG. 5, the optical source 610 is a two-stage laser system that includes a master oscillator 631 that provides a seed light beam 624 to power amplifier 630. The master oscillator 631 and the power amplifier 630 may be considered to be subsystems of the optical source 610 or systems that are part of the optical source 610. The power amplifier 630 receives the seed light beam 624 from the master oscillator 631 and amplifies the seed light beam 624 to generate the light beam 605 for use in the lithography exposure apparatus 669. For example, the master oscillator 631 may emit a pulsed seed light beam, with seed pulse energies of approximately 1 milliJoule (mJ) per pulse, and these seed pulses may be amplified by the power amplifier 630 to about 10 to 15 mJ.

The master oscillator 631 includes a discharge chamber 614 having two elongated electrodes 611A, a gain medium 612 that is a gas mixture, and a fan for circulating gas between the electrodes 611A in discharge chamber 614. A resonator is formed between a line narrowing module 616 on one side of the discharge chamber 614 and an output coupler 618 on a second side of the discharge chamber 614. The line narrowing module 616 may include a diffractive optic such as a grating that finely tunes the spectral output of the discharge chamber 614.

The master oscillator 631 also includes a line center analysis module 620 that receives an output light beam from the output coupler 618 and a beam coupling optical system 622 that modifies the size or shape of the output light beam as needed to form the seed light beam 624. The line center analysis module 620 is a measurement system that may be used to measure or monitor the wavelength of the seed light beam 624. The line center analysis module 620 may be placed at other locations in the optical source 610, or it may be placed at the output of the optical source 610.

The gas mixture used in the discharge chamber 614 may be any gas suitable for producing a light beam at the wavelength and bandwidth required for the application. For an excimer source, the gas mixture may contain a noble gas (rare gas) such as, for example, argon or krypton, a halogen, such as, for example, fluorine or chlorine and traces of xenon apart from helium and/or neon as a buffer gas. Specific examples of the gas mixture include argon fluoride (ArF), which emits light at a wavelength of about 193 nm, krypton fluoride (KrF), which emits light at a wavelength of about 248 nm, or xenon chloride (XeCl), which emits light at a wavelength of about 351 nm. The excimer gain medium (the gas mixture) is pumped with short (for example, nanosecond) current pulses in a high-voltage electric discharge by application of a voltage 609 to the elongated electrodes 611A.

The power amplifier 630 includes a beam coupling optical system 632 that receives the seed light beam 624 from the master oscillator 631 and directs the light beam through a discharge chamber 640, and to a beam turning optical element 648, which modifies or changes the direction of the seed light beam 624 so that it is sent back into the discharge chamber 640. The discharge chamber 640 includes a pair of elongated electrodes 611B, a gain medium 612 that is a gas mixture, and a fan for circulating the gas mixture between the electrodes 6111B.

The output light beam 605 is directed through a bandwidth analysis module 662, where various parameters (such as the bandwidth or the wavelength) of the beam 605 may be measured. The output light beam 605 may also be directed through a beam preparation system 663. The beam preparation system 663 may include, for example, a pulse stretcher, where each of the pulses of the output light beam 605 is stretched in time, for example, in an optical delay unit, to adjust for performance properties of the light beam that impinges the lithography exposure apparatus 669. The beam preparation system 663 also may include other components that are able to act upon the beam 605 such as, for example, reflective and/or refractive optical elements (such as, for example, lenses and mirrors), filters, and optical apertures (including automated shutters).

The light beam 605 is a pulsed light beam and may include one or more bursts of pulses that are separated from each other in time. Each burst may include one or more pulses of light. In some implementations, a burst includes hundreds of pulses, for example, 100-400 pulses.

As discussed above, when the gain medium 612 is pumped by applying voltage 609 to the electrodes 611A, the gain medium 612 emits light. When voltage 609 is applied to the electrodes 611A in pulses, the light emitted from the medium 612 is also pulsed. Thus, the repetition rate of the pulsed light beam 605 is determined by the rate at which voltage 609 is applied to the electrodes 611A, with each application of voltage 609 producing a pulse of light. The pulse of light propagates through the gain medium 612 and exits the chamber 614 through the output coupler 618. Thus, a train of pulses is created by periodic, repeated application of voltage 609 to the electrodes 611A. The repetition rate of the pulses may range between about 500 Hz and 6,000 Hz. In some implementations, the repetition rate is greater than 6,000 Hz, and may be, for example, 12,000 Hz or greater

The signals from the control system 250 may also be used to control the electrodes 611A, 611B within the master oscillator 631 and the power amplifier 630, respectively, for controlling the respective pulse energies of the master oscillator 631 and the power amplifier 630, and thus, the energy of the light beam 605. There may be a delay between the signal provided to the electrodes 611A and the signal provided to the electrodes 611B. The amount of delay may influence properties of the beam 605, such as the amount of coherence in the pulsed light beam 605. The pulsed light beam 605 may have an average output power in the range of tens of watts, for example, from about 50 W to about 130 W. The irradiance (that is, the average power per unit area) of the light beam 605 at the output may range from 60 W/cm² to 80 W/cm².

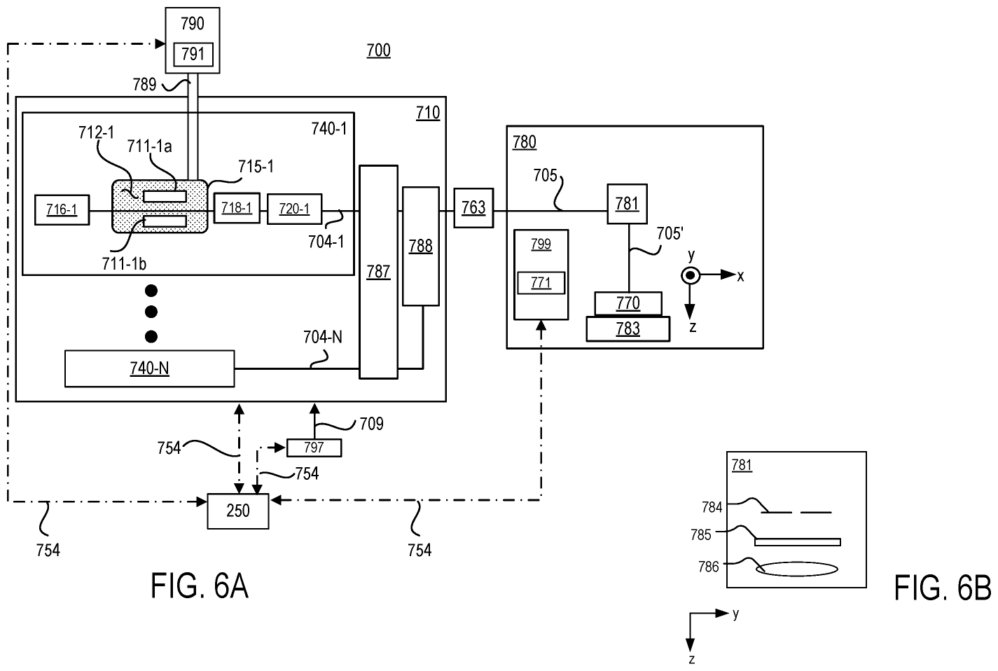

Referring to FIG. 6A, a block diagram of an optical lithography system 700 is shown. The optical lithography system 700 includes an optical source system 710, which produces an exposure beam 705 that is provided to a scanner apparatus 780. The scanner apparatus 780 exposes a wafer 770 with the exposure beam 705. In the example shown, the control system 250 is connected to the optical source system 710 and the scanner apparatus 780. In other examples, the control system 250 is connected only to the optical source system 710.

The scanner apparatus 780 exposes a wafer 770 with a shaped exposure beam 705′. The shaped exposure beam 705′ is formed by passing the exposure beam 705 through a projection optical system 781.

The optical source system 710 includes optical oscillators 740-1 to 740-N, where N is an integer number that is greater than one. Each optical oscillator 740-1 to 740-N generates a respective light beam 704-1 to 704-N. The details of the optical oscillator 740-1 are discussed below. The other N−1 optical oscillators in the optical source system 710 include the same or similar features.

The optical oscillator 740-1 includes a discharge chamber 715-1, which encloses a cathode 711-1a and an anode 711-1b. The discharge chamber 715-1 also contains a gaseous gain medium 712-1. A potential difference between the cathode 711-1a and the anode 711-1b forms an electric field in the gaseous gain medium 712-1. The potential difference may be generated by controlling a voltage source 797 coupled to the control system 250 to apply a voltage 709 to the cathode 711-1a and/or the anode 711-1b. The electric field provides energy to the gain medium 712-1 sufficient to cause a population inversion and to enable generation of a pulse of light via stimulated emission. Repeated creation of such a potential difference forms a train of pulses of light to make the light beam 704-1. The repetition rate of the pulsed light beam 704-1 is determined by the rate at which voltage 709 is applied to the electrodes 711-1a, 711-1b. The duration of the pulses in the pulsed light beam 704-1 is determined by the duration of the application of the voltage 709 to the electrodes 711-1a and 711-1b. The repetition rate of the pulses may range, for example, between about 500 Hz and 6,000 Hz. In some implementations, the repetition rate may be greater than 6,000 Hz, and may be, for example, 12,000 Hz or greater. Each pulse emitted from the optical oscillator 740-1 may have a pulse energy of, for example, approximately 1 milliJoule (mJ).

The gaseous gain medium 712-1 may be any gas suitable for producing a light beam at the wavelength, energy, and bandwidth required for the application. For an excimer source, the gaseous gain medium 712-1 may contain a noble gas (rare gas) such as, for example, argon or krypton, a halogen, such as, for example, fluorine or chlorine and traces of xenon apart from a buffer gas, such as helium. Specific examples of the gaseous gain medium 712-1 include argon fluoride (ArF), which emits light at a wavelength of about 193 nm, krypton fluoride (KrF), which emits light at a wavelength of about 248 nm, or xenon chloride (XeCl), which emits light at a wavelength of about 351 nm. The gain medium 712-1 is pumped with short (for example, nanosecond) current pulses in a high-voltage electric discharge by application of the voltage 709 to the electrodes 711-1a, 711-1b.

A resonator is formed between a line narrowing module 716-1 on one side of the discharge chamber 715-1 and an output coupler 718-1 on a second side of the discharge chamber 715-1. The line narrowing module 716-1 may include a diffractive optic such as, for example, a grating and/or a prism, that finely tunes the spectral output of the discharge chamber 715-1. In some implementations, the line narrowing module 716-1 includes a plurality of diffractive optical elements. For example, the line narrowing module 716-1 may include four prisms, some of which are configured to control a center wavelength of the light beam 704-1 and others of which are configured to control a spectral bandwidth of the light beam 704-1.

The optical oscillator 740-1 also includes a line center analysis module 720-1 that receives an output light beam from the output coupler 718-1. The line center analysis module 720-1 is a measurement system that may be used to measure or monitor the wavelength of the light beam 704-1. The line center analysis module 720-1 may provide data to the control system 250, and the control system 250 may determine metrics related to the light beam 704-1 based on the data from the line center analysis module 720-1. For example, the control system 250 may determine a beam quality metric or a spectral bandwidth based on the data measured by the line center analysis module 720-1.

The optical source system 710 also includes gas supply system 790 that is fluidly coupled to an interior of the discharge chamber 715-1 via a fluid conduit 789. The fluid conduit 789 is any conduit that is capable of transporting a gas or other fluid with no or minimal loss of the fluid. For example, the fluid conduit 789 may be a pipe that is made of or coated with a material that does not react with the fluid or fluids transported in the conduit 789. The gas supply system 790 includes a chamber 791 that contains and/or is configured to receive a supply of the gas or gasses used in the gain medium 712-1. The gas supply system 790 also includes devices (such as pumps, valves, and/or fluid switches) that enable the gas supply system 790 to remove gas from or inject gas into the discharge chamber 715-1. The gas supply system 790 is coupled to the control system 250. The gas supply system 790 may be controlled by the control system 250 to perform, for example, a refill procedure.

The other N−1 optical oscillators are similar to the optical oscillator 740-1 and have similar or the same components and subsystems. For example, each of the optical oscillators 740-1 to 740-N includes electrodes similar to the electrodes 711-1a, 711-1b, a line narrowing module similar to the line narrowing module 716-1, and an output coupler similar to the output coupler 718-1. The optical oscillators 740-1 to 740-N may be tuned or configured such that all of the light beams 704-1 to 704-N have the same properties or the optical oscillators 740-1 to 740-N may be tuned or configured such that at least some optical oscillators have at least some properties that are different from other optical oscillators. For example, all of the light beams 704-1 to 704-N may have the same center wavelength, or the center wavelength of each light beam 704-1 to 704-N may be different. The center wavelength produced by a particular one of the optical oscillators 740-1 to 740-N may be set using the respective line narrowing module.

Moreover, the voltage source 797 may be electrically connected to the electrodes in each optical oscillator 740-1 to 740-N, or the voltage source 797 may be implemented as a voltage system that includes N individual voltage sources, each of which is electrically connected to the electrodes of one of the optical oscillators 740-1 to 740-N.

The optical source system 710 also includes abeam control apparatus 787 and abeam combiner 788. The beam control apparatus 787 is between the gaseous gain media of the optical oscillators 740-1 to 740-N and the beam combiner 788. The beam control apparatus 787 determines which of the light beams 704-1 to 704-N are incident on the beam combiner 788. The beam combiner 788 forms the exposure beam 705 from the light beam or light beams that are incident on the beam combiner 788. In the example shown, the beam control apparatus 787 is represented as a single element. However, the beam control apparatus 787 may be implemented as a collection of individual beam control apparatuses. For example, the beam control apparatus 787 may include a collection of shutters, with one shutter being associated with each optical oscillator 740-1 to 740-N.

The optical source system 710 may include other components and systems. For example, the optical source system 710 may include a beam preparation system 763 that includes a bandwidth analysis module that measures various properties (such as the bandwidth or the wavelength) of a light beam. The beam preparation system 763 also may include a pulse stretcher (not shown) that stretches each pulse that interacts with the pulse stretcher in time. The beam preparation system 763 also may include other components that are able to act upon light such as, for example, reflective and/or refractive optical elements (such as, for example, lenses and mirrors), and/or filters. In the example shown, the beam preparation system 763 is positioned in the path of the exposure beam 705. However, the beam preparation system 763 may be placed at other locations within the optical lithography system 700. Moreover, other implementations are possible. For example, the optical source system 710 may include N instances of the beam preparation system 763, each of which is placed to interact with one of the light beams 704-1 to 704-N. In another example, the optical source system 810 may include optical elements (such as mirrors) that steer the light beams 704-1 to 704-N toward the beam combiner 788.

The scanner apparatus 780 may be a liquid immersion system or a dry system. The scanner apparatus 780 includes a projection optical system 781 through which the exposure beam 705 passes prior to reaching the wafer 770, and a sensor system or metrology system 799. The wafer 770 is held or received on a wafer holder 783. Referring also to FIG. 6B, the projection optical system 781 includes a slit 784, a mask 785, and a projection objective, which includes a lens system 786. The lens system 786 includes one or more optical elements. The exposure beam 705 enters the scanner apparatus 780 and impinges on the slit 784, and at least some of the beam 705 passes through the slit 784 to form the shaped exposure beam 705′. In the example of FIGS. 6A and 6B, the slit 784 is rectangular and shapes the exposure beam 705 into an elongated rectangular shaped light beam, which is the shaped exposure beam 705′. The mask 785 includes a pattern that determines which portions of the shaped light beam are transmitted by the mask 785 and which are blocked by the mask 785. Microelectronic features are formed on the wafer 770 by exposing a layer of radiation-sensitive photoresist material on the wafer 770 with the exposure beam 705′. The design of the pattern on the mask is determined by the specific microelectronic circuit features that are desired.

The metrology system 799 includes a sensor 771. The sensor 771 may be configured to measure a property of the shaped exposure beam 705′ such as, for example, bandwidth, energy, pulse duration, and/or wavelength. The sensor 771 may be, for example, a camera or other device that is able to capture an image of the shaped exposure beam 705′ at the wafer 770, or an energy detector that is able to capture data that describes the amount of optical energy at the wafer 770 in the x-y plane.

Although specific reference may have been made above to the use of embodiments in the context of optical lithography, it will be appreciated that embodiments may be used in other applications, for example imprint lithography, and where the context allows, is not limited to optical lithography. It is to be understood that the phraseology or terminology herein is for the purpose of description and not of limitation, such that the terminology or phraseology of the present specification is to be interpreted by those skilled in relevant art(s) in light of the teachings herein.

It is to be appreciated that the Detailed Description section, and not the Summary and Abstract sections, is intended to be used to interpret the claims. The Summary and Abstract sections may set forth one or more but not all exemplary embodiments as contemplated by the inventor(s), and thus, are not intended to limit the embodiments and the appended claims in any way.

The embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the embodiments that others can, by applying knowledge within the skill of the art, readily modify and/or adapt for various applications such specific embodiments, without undue experimentation, without departing from the general concept of the embodiments. Therefore, such adaptations and modifications are intended to be within the meaning and range of equivalents of the disclosed embodiments, based on the teaching and guidance presented herein.

The breadth and scope of the embodiments should not be limited by any of the above-described exemplary embodiments but should be defined only in accordance with the following claims and their equivalents.

The embodiments can be further described using the following clauses.
1. A method of determining whether to perform cold start conditioning in restarting a laser after a most recent idle period, the laser having a laser chamber, the method comprising:
before the most recent idle period, determining an idle duration trigger threshold based at least in part on a shot count of the laser chamber; and determining whether to perform cold start conditioning after the most recent idle period based at least in part on whether a duration of the most recent idle period exceeds the idle duration trigger threshold.
2. The method of clause 1 wherein determining an idle duration trigger threshold based at least in part on a shot count comprises determining an idle duration trigger threshold based at least in part on the shot count and on a measured energy of a beam emitted by the laser after an earlier idle period.
3. The method of clause 1 wherein the cold start conditioning comprises firing a predetermined number of inoperative pulses.
4. A method of determining whether to perform cold start conditioning in restarting a laser after a most recent idle period, the laser having a laser chamber, the method comprising:
making a chamber age determination of whether a shot count of the chamber is less than a first predetermined shot count and setting an idle duration trigger threshold to a default idle duration trigger threshold if the shot count of the chamber is less than the first predetermined shot count;
if the chamber age determination is negative, then making a beam energy determination by recording a duration of an earlier idle period, evaluating an energy of a laser beam exiting the laser after a cold start from the earlier idle period, and if the beam energy exceeds a threshold amount, setting the idle duration trigger threshold based at least in part on the duration of the earlier idle period and the beam energy;
if the beam energy determination is negative, then making a shot count determination based on whether a shot count for the chamber exceeds a predetermined trigger shot count threshold and, if an idle duration exceeds a scheduled adjustable idle duration trigger threshold, then setting the idle duration trigger threshold equal to an adjustable idle duration trigger threshold; and deciding to perform cold start conditioning based at least in part on whether the duration of the most recent idle period exceeds the idle duration trigger threshold.
5. The method of clause 4 wherein making a beam energy determination further comprises modifying the adjustable idle duration trigger threshold.
6. The method of clause 4 wherein the cold start conditioning comprises firing a predetermined number of inoperative pulses.
7. A method of determining whether to perform cold start conditioning in restarting a laser after a most recent idle period, the laser having a laser chamber, the method comprising:
making a first determination of whether an age of the chamber is less than a predetermined age and a duration of the most recent idle period exceeds a default idle duration trigger threshold and performing cold start conditioning if the first determination is affirmative;
if the first determination is negative, making a second determination of a duration of the most recent idle period exceeds a then-current idle duration trigger threshold and an energy of a laser beam exiting the laser during an earlier idle period is less than a beam energy trigger threshold and performing cold start conditioning if the second determination is affirmative; and
if the second determination is negative, making a third determination of whether a shot count of the chamber exceeds a shot count trigger threshold and the duration of the most recent idle period exceeds an adjustable idle duration trigger threshold and performing cold start conditioning if the third determination is affirmative.
8. The method of clause 7 wherein determining to perform cold start conditioning if a duration of the most recent idle period exceeds an idle duration trigger threshold and an energy of a laser beam exiting the laser during the earlier idle period is less than a beam energy trigger threshold further comprises setting the idle duration trigger threshold equal to the duration of the most recent idle period.
9. The method of clause 7 wherein determining to perform cold start conditioning if a duration of the most recent idle period exceeds an idle duration trigger threshold and an energy of a laser beam exiting the laser during an earlier idle period is less than a beam energy trigger threshold further comprises modifying the adjustable idle duration trigger threshold.
10. The method of clause 7 wherein the cold start conditioning comprises firing a predetermined number of inoperative pulses.
11. A system for determining whether to perform cold start conditioning in restarting a laser after an idle period, the laser having a laser chamber, the system comprising:
a shot count monitor adapted to monitor a number of shots fired by the laser chamber;
an idle period duration monitor adapted to monitor and record respective durations of idle periods when the laser has been idle;
a beam energy monitor adapted to monitor an energy of a beam of laser radiation emitted by the laser; and
a controller responsively connected to the shot count monitor, the idle period duration monitor, and the beam energy monitor and adapted to determine whether to perform cold start conditioning based on at least one of
whether the shot count is below a first predetermined shot count indicating that the chamber is new or has been replaced,
whether the shot count is above a second predetermined shot count,
a duration of a period when the laser has most recently been idle, and
an energy of a beam of laser radiation emitted by the laser after an earlier idle period.
12. The system of clause 11 wherein the cold start conditioning comprises firing a predetermined number of inoperative pulses.
13. The system of clause 11 wherein the controller is adapted to determine whether to perform cold start conditioning by comparing the idle period duration and an idle duration trigger threshold, the idle duration trigger threshold being based on at least one of
whether the shot count is below a first predetermined shot count indicating that the chamber is new or has been replaced,
whether the shot count is above a second predetermined shot count,
a duration of a period when the laser has most recently been idle, and
an energy of a beam of laser radiation emitted by the laser after an earlier idle period.
14. The system of clause 13 wherein the controller is adapted to determine the idle duration trigger threshold by making a chamber age determination of whether a shot count of the chamber is less than a first predetermined shot count and setting an idle duration trigger threshold to a default idle duration trigger threshold if the shot count of the chamber is less than the first predetermined shot count.
15. The system of clause 13 wherein the controller is adapted to determine the idle duration trigger threshold by making a beam energy determination by recording a duration of an earlier idle period, evaluating an energy of a laser beam exiting the laser after a cold start from the earlier idle period, and if the beam energy exceeds a threshold amount, setting the idle duration trigger threshold based at least in part on the duration of the earlier idle period and the beam energy.
16. The system of clause 13 wherein the controller is adapted to determine the idle duration trigger threshold by making a shot count determination based on whether a shot count for the chamber exceeds a predetermined trigger shot count threshold and, if an idle duration exceeds a scheduled adjustable idle duration trigger threshold, then setting the idle duration trigger threshold equal to an adjustable idle duration trigger threshold.

The above described implementations and other implementations are within the scope of the following claims.

1. A method of determining whether to perform conditioning in restarting a laser after a most recent idle period, the laser having a laser chamber, the method comprising:
before the most recent idle period, determining an idle duration trigger threshold based at least in part on a shot count of the laser chamber; and
determining whether to perform cold start conditioning after the most recent idle period based at least in part on whether a duration of the most recent idle period exceeds the idle duration trigger threshold.

2. The method of claim 1 wherein determining the idle duration trigger threshold based at least in part on the shot count comprises determining the idle duration trigger threshold based at least in part on the shot count and on a measured energy of a beam emitted by the laser chamber after an earlier idle period.

3. The method of claim 1 wherein performing the conditioning comprises firing a predetermined number of inoperative pulses.

4. A method of determining whether to perform conditioning in restarting a laser after a most recent idle period, the laser having a chamber, the method comprising:
making a chamber age determination of whether a shot count of the chamber is less than a first predetermined shot count and setting an idle duration trigger threshold to a default idle duration trigger threshold if the shot count of the chamber is less than the first predetermined shot count;
if the chamber age determination is negative, then making a beam energy determination by recording a duration of an earlier idle period, evaluating an energy of a laser beam exiting the laser after a start from the earlier idle period, and if the beam energy exceeds a threshold amount, setting the idle duration trigger threshold based at least in part on the duration of the earlier idle period and the beam energy;
if the beam energy determination is negative, then making a shot count determination based on whether a shot count for the chamber exceeds a predetermined trigger shot count threshold and, if an idle duration exceeds a scheduled adjustable idle duration trigger threshold, then setting the idle duration trigger threshold equal to an adjustable idle duration trigger threshold; and
deciding to perform conditioning based at least in part on whether the duration of the most recent idle period exceeds the idle duration trigger threshold.

5. The method of claim 4 wherein making a beam energy determination further comprises modifying the adjustable idle duration trigger threshold.

6. The method of claim 4 wherein performing the conditioning comprises firing a predetermined number of inoperative pulses.

7. A method of determining whether to perform cold start conditioning in restarting a laser after a most recent idle period, the laser having a chamber, the method comprising:
making a first determination of whether an age of the chamber is less than a predetermined age and whether a duration of the most recent idle period exceeds a default idle duration trigger threshold and performing cold start conditioning if the first determination is affirmative;
if the first determination is negative, making a second determination of whether a duration of the most recent idle period exceeds a then-current idle duration trigger threshold and whether an energy of a laser beam exiting the laser during an earlier idle period is less than a beam energy trigger threshold and performing cold start conditioning if the second determination is affirmative; and
if the second determination is negative, making a third determination of whether a shot count of the chamber exceeds a shot count trigger threshold and whether the duration of the most recent idle period exceeds an adjustable idle duration trigger threshold and performing cold start conditioning if the third determination is affirmative.

8. The method of claim 7 wherein making the second determination further comprises setting the then-current idle duration trigger threshold equal to the duration of the most recent idle period.

9. The method of claim 7 wherein making the second determination further comprises modifying the adjustable idle duration trigger threshold.

10. The method of claim 7 wherein performing cold start conditioning comprises firing a predetermined number of inoperative pulses.

11. A system for determining whether to perform cold start conditioning in restarting a laser after an idle period, the laser having a chamber, the system comprising:
a shot count monitor adapted to monitor a number of shots fired by the chamber;
an idle period duration monitor adapted to monitor and record respective durations of idle periods when the laser has been idle;
a beam energy monitor adapted to monitor an energy of a beam of laser radiation emitted by the laser; and
a controller responsively connected to the shot count monitor, the idle period duration monitor, and the beam energy monitor and adapted to determine whether to perform cold start conditioning based on at least one of
whether the number of shots is below a first predetermined shot count indicating that the chamber is new or has been replaced,
whether the number of shots is above a second predetermined shot count,
a duration of a period when the laser has most recently been idle, and
an energy of a beam of laser radiation emitted from the chamber after an earlier idle period.

12. The system of claim 11 wherein the cold start conditioning comprises firing a predetermined number of inoperative pulses.

13. The system of claim 11 wherein the controller is adapted to determine whether to perform cold start conditioning by comparing the idle period duration and an idle duration trigger threshold, the idle duration trigger threshold being based on at least one of
whether the number of shots is below the first predetermined shot count indicating that the chamber is new or has been replaced,
whether the number of shots is below the second predetermined shot count,
the duration of the period when the laser has most recently been idle, and
the energy of the beam of laser radiation emitted from the after the earlier idle period.

14. The system of claim 13 wherein the controller is adapted to determine the idle duration trigger threshold by making a chamber age determination of whether the number of shots is less than the first predetermined shot count and setting the idle duration trigger threshold to a default idle duration trigger threshold if the number of shots is less than the first predetermined shot count.

15. The system of claim 13 wherein the controller is adapted to determine the idle duration trigger threshold by making a beam energy determination by recording a duration of the earlier idle period, evaluating the energy of the beam of laser emitting form the chamber after a start from the earlier idle period, and if the beam energy exceeds a threshold amount, setting the idle duration trigger threshold based at least in part on the duration of the earlier idle period and the beam energy.

16. The system of claim 13 wherein the controller is adapted to determine the idle duration trigger threshold by making a shot count determination based on whether a shot count for the chamber exceeds a predetermined trigger shot count threshold and, if an idle duration exceeds a scheduled adjustable idle duration trigger threshold, then setting the idle duration trigger threshold equal to an adjustable idle duration trigger threshold.

17. The method of claim 1, further comprising:
before the most recent idle period, determine whether the laser chamber is new or has been replaced; and
in response to a determination that the laser chamber is replaced, resetting the shot count of the laser chamber.
